(19) United States
(12) Patent Application Publication
(10) Pub. No.: US 2023/0324885 A1
(43) Pub. Date: Oct. 12, 2023

(54) CONTROL ASSISTANCE DEVICE, CONTROL SYSTEM, AND CONTROL ASSISTANCE METHOD

(71) Applicant: FANUC CORPORATION, Minamitsuru-gun, Yamanashi (JP)

(72) Inventor: Ryoutarou TSUNEKI, Yamanashi (JP)

(21) Appl. No.: 18/015,805

(22) PCT Filed: Jul. 29, 2021
(86) PCT No.: PCT/JP2021/028041

§ 371 Date: Jan. 12, 2023

(30) Foreign Application Priority Data
Aug. 5, 2020 (JP) 2020-133203

(51) Int. Cl. G05B 19/4155

(52) U.S. Cl. CPC G05B 19/4155; G05B 2219/34013

(57) ABSTRACT

A control assistance device implements assistance in order to adjust a coefficient for a plurality of filters provided to a servo control device. The control assistance device comprises: a resonance detection unit that detects a plurality of resonance points in frequency characteristics between an input/output gain and an input/output phase shift, of the servo control device, measured on the basis of an input signal and an output signal having varying frequencies; and a resonance evaluation unit that calculates the priority levels of the plurality of resonance points. The resonance evaluation unit calculates the priority level on the basis of a distance between a point (-1,0) or a point (k, 0) (where k is a value less than -1) on a real axis on a complex plane, and a resonance point on a Nyquist locus calculated from the frequency characteristics between the input/output gain and the input/output phase shift.

### TECHNICAL FIELD

The present invention relates to a control assistance device for adjusting coefficients for a plurality of filters of a servo control device that controls a motor, a control system including the control assistance device and the servo control device, and a control assistance method.

### BACKGROUND ART

For example, Japanese Unexamined Patent Application, Publication No. 2020-57211 discloses a control system including a servo control device that suppresses a plurality of resonance points by a plurality of filters in a machine having a plurality of resonance points, and a machine learning device that optimizes coefficients of the filters. Japanese Unexamined Patent Application, Publication No. 2020-57211 discloses the control system that, when there are a plurality of resonance pints in a machine, provides and connects in series a plurality of filters in a servo control unit (to be the servo control device) to correspond to each of the resonance points to attenuate all resonances. Further, Japanese Unexamined Patent Application, Publication No. 2020-57211 discloses that the machine learning device acquires optimal values for attenuating the resonance points in order for the coefficients of a plurality of filters by machine learning.

Patent Document 1: Japanese Unexamined Patent Application, Publication No.2020-57211

### DISCLOSURE OF THE INVENTION

### Problems to Be Solved by the Invention

When there are a plurality of resonance points, if a plurality of filters are adjusted in a state where which resonance is most important is unknown for increasing the gain of the servo control device, the filters may be applied in an ineffectual manner. Thus, it is desired to apply the filters in order from the resonance point with the highest priority level.

### Means for Solving the Problems

A first aspect of the present disclosure is directed to a control assistance device that performs assistance for adjusting a coefficient for a plurality of filters provided to a servo control device that controls a motor, the control assistance device including: a resonance detection unit that detects a plurality of resonance points in frequency characteristics of an input/output gain and an input/output phase shift, of the servo control device, measured based on an input signal and an output signal having varying frequencies; and a resonance evaluation unit that calculates priority levels of the plurality of resonance points. The resonance evaluation unit calculates the priority levels on the basis of a distance between a point (-1, 0) or a point (k, 0) (where k is a value less than -1) on a real axis on a complex plane, and a resonance point on a Nyquist locus calculated from the frequency characteristics of the input/output gain and the input/output phase shift.

A second aspect of the present disclosure is directed to a control system including: a servo control device that controls a motor; and the control assistance device according to (1) above. The control assistance device: detects the plurality of resonance points in the frequency characteristics of the input/output gain and the input/output phase shift of the servo control device; and calculates the priority levels of the plurality of resonance points.

A third aspect of the present disclosure is directed to a control assistance method for a control assistance device that performs assistance for adjusting a coefficient for a plurality of filters provided to a servo control device that controls a motor. The control assistance method includes: detecting a plurality of resonance points in frequency characteristics of an input/output gain and an input/output phase shift, of the servo control device, measured based on an input signal and an output signal having varying frequencies; and calculating priority levels of the plurality of resonance points on the basis of a distance between a point (-1, 0) or a point (k, 0) (where k is a value less than -1) on a real axis on a complex plane, and a resonance point on a Nyquist locus calculated from the frequency characteristics of the input/output gain and the input/output phase shift.

### Effects of the Invention

According to each of the aspects of the present disclosure, it is possible to acquire the priority levels of the resonance points. As a result, it is possible to allocate the filter in order from the resonance point with the highest priority level.

### BRIEF DESCRIPTION OF THE DRAWINGS

FIG. 1 is a block diagram showing a control system according to a first embodiment of the present disclosure.

FIG. 2 is a block diagram showing an example where a filter is configured by directly connecting a plurality of filters.

FIG. 3 is a bode diagram showing the frequency characteristics of the input/output gain and phase shift.

FIG. 4 is a diagram showing, on a complex plane, a Nyquist locus, a unit circle, and a circle centered at (k, 0), which passes through the gain margin and the phase margin.

FIG. 5 is an explanatory diagram of the gain margin and the phase margin as well as the circle centered at the point on the real axis on the complex plane, which passes through the gain margin and the phase margin.

FIG. 6 is a flowchart showing an operation of a control assistance unit shown in FIG. 1.

FIG. 7 is a block diagram showing a control system according to a second embodiment of the present disclosure.

FIG. 8 is a block diagram showing a control system according to a third embodiment of the present disclosure.

FIG. 9 is a block diagram showing a machine learning unit according to an embodiment of the present invention.

FIG. 10 is a block diagram to be a model for calculating a normative model of the input/output gain.

FIG. 11 is a characteristic diagram showing the frequency characteristic of the input/output gain of the servo control unit of the normative model and the frequency characteristic of the input/output gain of the servo control unit before and after learning.

FIG. 12 is a block diagram showing a Modification Example of the control system shown in FIG. 1.

FIG. 13 is a block diagram showing another Modification Example of the control system.

### PREFERRED MODE FOR CARRYING OUT THE INVENTION

Hereinafter, embodiments of the present disclosure will be described in detail with reference to the accompanying drawings.

### First Embodiment

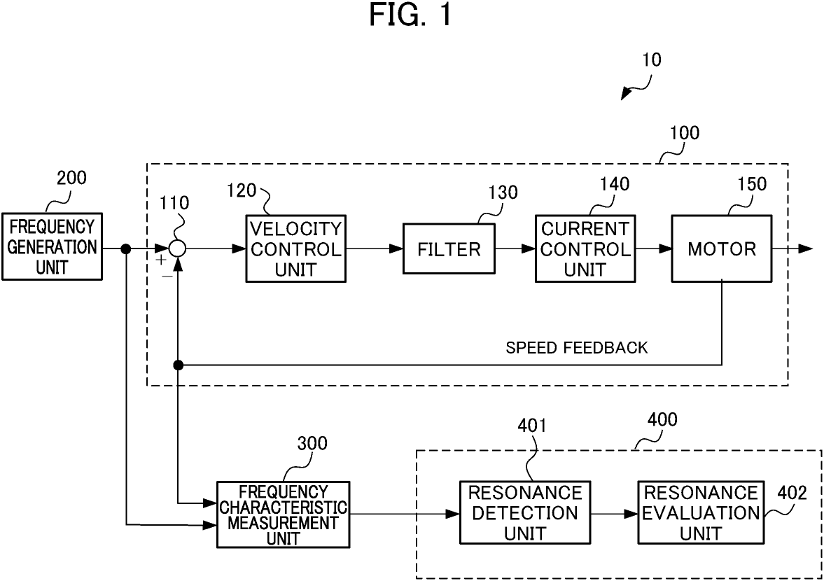

FIG. 1 is a block diagram showing a control system according to a first embodiment of the present disclosure. A control system 10 includes a servo control unit 100, a frequency generation unit 200, a frequency characteristic measurement unit 300, and a control assistance unit 400. The servo control unit 100 corresponds to a servo control device that controls a motor, the frequency characteristic measurement unit 300 corresponds to a frequency characteristic measurement device, and the control assistance unit 400 corresponds to a control assistance device. Note that one or a plurality of those among the frequency generation unit 200, the frequency characteristic measurement unit 300, and the control assistance unit 400 may be provided within the servo control unit 100. The frequency characteristic measurement unit 300 may be provided within the control assistance unit 400.

The servo control unit 100 includes a subtractor 110, a velocity control unit 120, a filter 130, a current control unit 140, and a motor 150. The subtractor 110, the velocity control unit 120, the filter 130, the current control unit 140, and the motor 150 configure a servo system of a speed feedback loop.

The motor 150 is a motor or the like having a linear motor for linear motion or a rotary axis. The targets to be driven by the motor 150 may be a machine tool, a robot, and a mechanical unit of an industrial machine, for example. The motor 150 may be provided as part of the machine tool, the robot, the industrial machine, or the like. The control system 10 may be provided as part of the machine tool, the robot, the industrial machine, or the like.

The subtractor 110 acquires a difference between an input speed command and a fed-back detection speed, and outputs the difference as a speed error to the velocity control unit 120.

The velocity control unit 120 performs PI control (Proportional Integral Control) to add an integrated value of the product of the speed error and an integral gain K1v and a value obtained by multiplying the speed error by a proportional gain K2v to the speed error, and outputs the addition value as a torque command to the filter 130. The velocity control unit 120 includes the feedback gain. Note that the velocity control unit 120 is not specifically limited to use the PI control but may also use other controls such as PID control (Proportional-Integral-Differential Control), for example. Mathematical expression 1 (hereinafter shown as Expression 1) represents a transfer function Gv(s) of the velocity control unit 120.

$${G}_{V} \left(s\right) = \frac{K 1 v}{s} + K 2 v \qquad \text{[Expression 1]}$$

The filter 130 is configured by connecting in series a plurality of filters for attenuating a specific frequency component. Each of the filters is a notch filter, a low-pass filter, or a band-stop filter, for example. In a machine such as a machine tool having a mechanical unit to be driven by the motor 150, a plurality of resonance points may exist, so that each resonance may increase in the servo control unit 100. By connecting the filters, such as the notch filters, in series, each resonance at a plurality of resonance points can be reduced. The output of the filter 130 is output as a torque command to the current control unit 140.

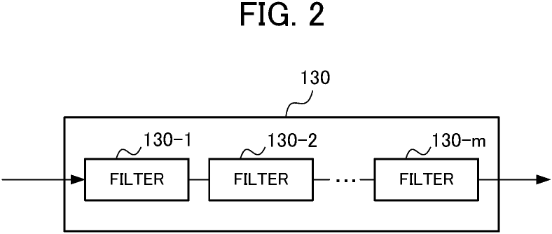

FIG. 2 is a block diagram showing an example where the filter 130 is configured by directly connecting a plurality of filters. Referring to FIG. 2, where there are n (n represents a natural number of 2 or more) resonance points, the filter 130 is configured by connecting m filters 130-1 to 130-m (m represents a natural number of 2 or more, and m≤n is to be satisfied) in series. The m filters 130-1 to 130-m correspond to frequency bandwidths different from each other. Hereinafter, description will be given assuming that the filter 130 is configured with the m filters 130-1 to 130-m. Mathematical expression 2 (hereinafter shown as Expression 2) represents a transfer function G_{F} (s) of a notch filter as the filter 130-1, for example, which is one filter within the filter 130. Each of the filters 130-2 to 130-m can also be configured with a notch filter of a similar transfer function. The coefficient δ in Expression 2 is an attenuation coefficient, the coefficient ω_{c} is a central angle frequency, and the coefficient τ is a specific bandwidth. Assuming that the center frequency is represented by fc and the bandwidth is represented by fw, the coefficient ω_{c} is represented by ω_{c} = 2nfc, and the coefficient τ is represented by τ = fw/fc.

$${G}_{F} \left(s\right) = \frac{{s}^{2} + 2 δ τ {ω}_{c} s + {ω}_{c} {}^{2}}{{s}^{2} + 2 τ {ω}_{c} s + {ω}_{c} {}^{2}} \qquad \text{[Expression 2]}$$

The current control unit 140 generates a voltage command for driving the motor 150 based on the torque command, and outputs the voltage command to the motor 150. When the motor 150 is a linear motor, the position of a movable part is detected by a linear scale (not shown) provided in the motor 150, the position detection value is differentiated to acquire a speed detection value, and the acquired speed detection value is input as speed feedback to the subtractor 110. When the motor 150 is a motor having a rotary axis, the rotation angle position is detected by a rotary type encoder (not shown) provided in the motor 150, and the speed detection value is input as speed feedback to the subtractor 110.

The servo control unit 100 is configured as described above. In order to operate the servo control unit 100 having no filter 130 provided therein to detect a plurality of resonance points and calculate the resonance point with the highest priority level, the control system 10 further includes the frequency generation unit 200, the frequency characteristic measurement unit 300, and the control assistance unit 400. The frequency characteristic measurement unit 300 may be included in the control assistance unit 400.

The frequency generation unit 200 outputs a sinusoidal signal as a speed command to the subtractor 110 of the servo control unit 100 and the frequency characteristic measurement unit 300 while changing the frequency. At this time, the filter 130 is not provided in the servo control unit 100.

The frequency characteristic measurement unit 300 uses a speed command (sinusoidal wave) to be an input signal generated by the frequency generation unit 200 and a detection speed (sinusoidal wave) to be an output signal output from a rotary type encoder (not shown) to measure an amplitude ratio (input/output gain) between the input signal and the output signal and a phase shift for each frequency specified by the speed command. Alternatively, the frequency characteristic measurement unit 300 uses a speed command (sinusoidal wave) to be an input signal generated by the frequency generation unit 200 and differentiation of the detection position (sinusoidal wave) to be an output signal output from a linear scale to measure an amplitude ratio between the input signal and the output signal and a phase shift for each frequency specified by the speed command.

The servo control unit 100 inputs the detection speed or the differentiation of the detection position to the frequency characteristic measurement unit 300. The frequency characteristic measurement unit 300 measures and outputs, to the control assistance unit 400, the frequency characteristics of the amplitude ratio (input/output gain) between the speed command to be the input signal and the output signal, and the phase shift.

The control assistance unit 400 detects the resonance points in the frequency characteristics of the input/output gain (amplitude ratio) and the phase shift output from the frequency characteristic measurement unit 300, and calculates the priority levels of the resonance points to determine resonance points with higher priority levels. Hereinafter, the configuration of the control assistance unit 400 and details of the operation thereof will be described further.

### (Control Assistance Unit 400)

As shown in FIG. 1, the control assistance unit 400 includes a resonance detection unit 401 and a resonance evaluation unit 402.

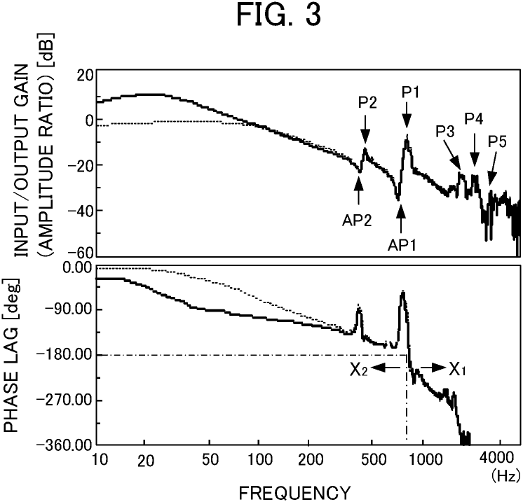

The resonance detection unit 401 acquires the frequency characteristics of the input/output gain (amplitude ratio) and the phase shift of the servo control unit 100 from the frequency characteristic measurement unit 300, and detects the resonance points in the frequency characteristics of the input/output gain and the phase shift. FIG. 3 is a bode diagram showing the frequency characteristics of the input/output gain and the phase shift. The curve shown with a solid line represents the frequency characteristic of an open loop, and the curve shown with a dotted line represents the frequency characteristic of a closed loop. In FIG. 3, there are five resonance points P1, P2, P3, P4, and P5.

Hereinafter, a method of acquiring the frequency characteristic of the open loop will be described. The speed feedback loop is configured with the subtractor 110 and an open-loop circuit of a transfer function H. The open-loop circuit is configured with the velocity control unit 120, the current control unit 140, and the motor 150 shown in FIG. 1. Assuming that the input/output gain of the speed feedback loop is c and the phase shift is θ at a certain frequency ω₀, the closed-loop frequency characteristic G(jω₀) is represented by c·e^{jθ}. By using the open-loop frequency characteristic H(jω₀), the closed-loop frequency characteristic G(jω₀) is represented by G (jω₀) = H (jω₀) / (1+H (jω₀) ) . Therefore, the open-loop frequency characteristic H(jω₀) at a certain frequency ω₀ can be determined by H (jω₀) = G (jω₀) / (1-G (1-G (jω₀) ) = c ∘e^{jθ}/ (1-c ·e^{jθ}) .

When the changing frequency is represented by ω, the open-loop frequency characteristic H (jω) can be acquired by the relational expression H (jω) = G (jω) / (1-G(jω)), as described above. The resonance detection unit 401 uses the frequency characteristic (closed-loop frequency characteristic) of the input/output gain (amplitude ratio) and the phase shift of the servo control unit 100 acquired from the frequency characteristic measurement unit 300 to acquire the open-loop frequency characteristic H (jω) . Then, the resonance evaluation unit 402 to be described later creates a Nyquist locus by drawing the open-loop frequency characteristic H (jω) on a complex plane.

The resonance detection unit 401 may detect antiresonance points other than the resonance points. By detecting the antiresonance points, when setting the range of attenuation center frequency of each of the m filters 130-1 to 130-m, it can be set between the frequencies of the antiresonance points. In FIG. 3, antiresonance points AP1, AP2 near the resonance points P1, P2 are shown as examples.

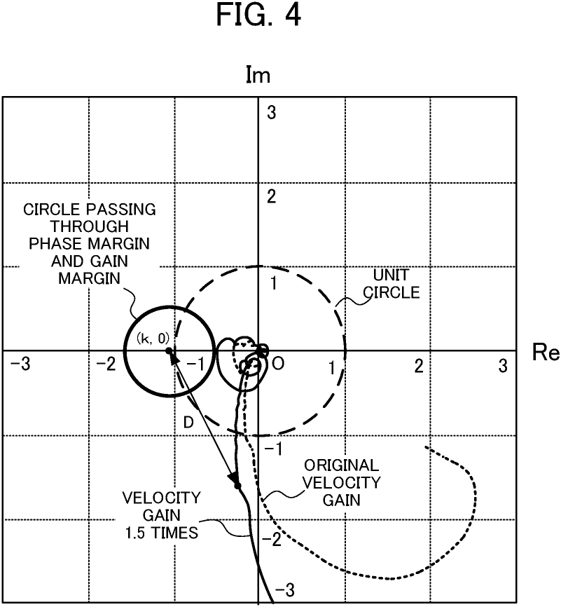

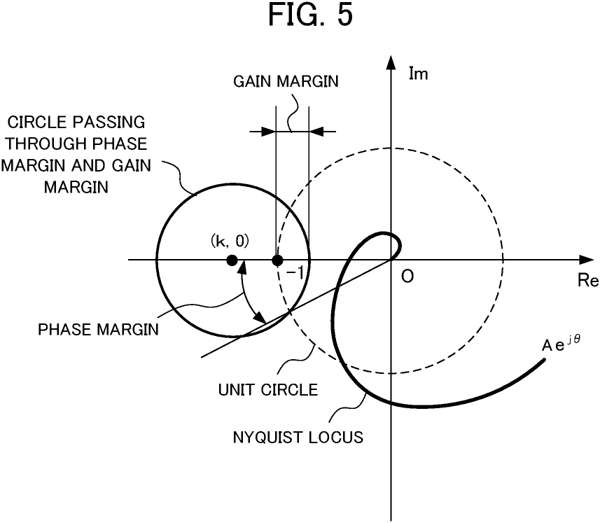

The resonance evaluation unit 402 calculates the priority levels of the resonance points to determine resonance points with higher priority levels. Specifically, the resonance evaluation unit 402 calculates the priority level on the basis of the distance between the resonance point on the Nyquist locus and the point on the real axis on the complex plane. Here, the point on the real axis on the complex plane is determined by taking the gain margin and the phase margin of the open-loop circuit of the servo control unit 100 into consideration, for example. As shown in FIG. 5, intersection points of the circle centered at the point on the real axis on the complex plane and the unit circle passing through (-1, 0) are the gain margin and the phase margin. The point on the real axis on the complex plane is defined as (-1, 0) or (k, 0) (k is a value smaller than -1). The value k is determined by the user by taking the gain margin and the phase margin into consideration. FIG. 4 is a diagram showing, on the complex plane, a Nyquist locus, a unit circle, and a circle centered at (k, 0), which passes through the gain margin and the phase margin. FIG. 5 is an explanatory diagram of the gain margin and the phase margin as well as the circle centered at the point on the real axis on the complex plane, which passes through the gain margin and the phase margin. The resonance evaluation unit 402 increases the priority level of the resonance point on the Nyquist locus closer to the point on the real axis on the complex plane, for example. The distance between the resonance point on the Nyquist locus and the point on the real axis is a distance D indicated by an arrow in FIG. 4, for example.

As will be described below, the resonance evaluation unit 402 may calculate the priority level based on the distance between the resonance point on the Nyquist locus and the point on the real axis on the complex plane, and the magnitude of the resonance frequency. First, in a frequency zone where frequency is lower than a high frequency zone, the resonance evaluation unit 402 calculates the priority levels based on the distance between each of the resonance points on the Nyquist locus and the point on the real axis on the complex plane. The high frequency zone is a frequency zone where the phase shift is -180 degrees or more, or a frequency zone where the gain characteristic is smaller than -6 dB, for example. After calculating the priority levels in the frequency zone where frequency is lower than the high frequency zone, the resonance evaluation unit 402 calculates the priority levels in the high frequency zone in the same manner as that of the frequency zone where frequency is lower than the high frequency zone based on the distance between the resonance points on the Nyquist locus and the point on the real axis on the complex plane. The priority levels of the resonance points are determined first in the frequency zone where frequency is lower than the high frequency zone because the influence of the resonance upon the stability is small in the high frequency zone where the input/output gain becomes sufficiently small.

FIG. 4 shows the Nyquist locus in the original velocity gain (shown with a dotted line) and the Nyquist locus in the velocity gain that is 1.5 times with respect to the original velocity gain. When the velocity gain is increased, the resonance point P1 shown in FIG. 3 first comes to hit the stability limit shown in FIG. 5 to be described later. The velocity gain can be changed by changing at least one selected from the integral gain K1v and the proportional gain K2v of Mathematical expression 1.

While the description given above refers to the circle centered at the point on the real axis on the complex plane, it is not specifically limited to a circle but may also be a closed curve other than a circle, such as an ellipse or the like, for example. Further, while the description given above is on the case of operating the servo control unit 100 having no filter 130 provided therein to acquire the frequency characteristics of the input/output gain (amplitude ratio) and the phase shift and detecting the resonance points, the frequency characteristics of the input/output gain and the phase shift when there is no filter 130 may also be acquired by other methods. For example, by using each of the coefficients ω_{c}, τ, and δ of the transfer function of the filter 130, the frequency characteristics of the input/output gain and the phase shift are calculated. Then, the servo control unit 100 having the filter 130 provided therein is operated to acquire the frequency characteristics of the input/output gain and the phase shift and, from the frequency characteristic, the frequency characteristics of the input/output gain and the phase shift of the filter 130 are subtracted. By the subtraction processing, it is possible to acquire the frequency characteristics of the input/output gain and the phase shift in the case of having no filter 130.

The function blocks included in the control system 10 have been described above. In order to implement those function blocks, the control system 10, the servo control unit 100, or the control assistance unit 400 includes an operation processing device such as a CPU (Central Processing Unit). Further, the control system 10, the servo control unit 100, or the control assistance unit 400 includes an auxiliary storage device such as HDD (Hard Disk Drive) in which various control programs such as application software and OS (Operating System) are stored, and a main storage device such as RAM (Random Access Memory) for storing data temporarily required for the operation processing device to execute a program.

Further, in the control system 10, the servo control unit 100, or the control assistance unit 400, the operation processing device reads out the application software or the OS from the auxiliary storage device, and performs operation processing based on the application software or the OS while deploying the read-out application software or the OS on the main storage device. The operation processing device controls various types of hardware disposed in respective devices based on the operation result. In this way, the function blocks of the present embodiment are implemented. That is, the present embodiment can be implemented by the cooperation of hardware and software.

When the control assistance unit 400 has a large amount of operations, for example, a personal computer may be equipped with GPU (Graphics Processing Units), so that it is possible to perform high speed processing by using GPU for operation processing by a technique called GPGPU (General-Purpose computing on Graphics Processing Units). Further, in order to perform still higher speed processing, a computer cluster may be built using a plurality of such computers equipped with GPUs to perform parallel processing by a plurality of computers included in the computer cluster.

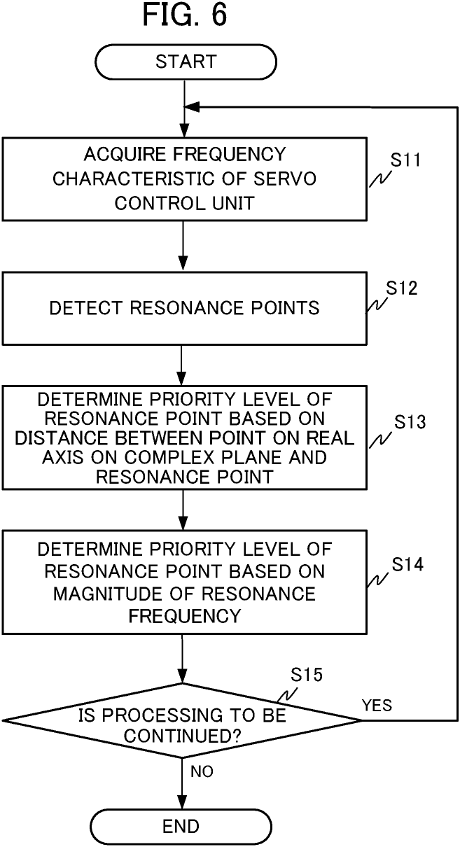

Next, the operation of the control assistance unit 400 will be described with reference to a flowchart. FIG. 6 is the flowchart indicating the operation of the control assistance unit.

In Step S11, the resonance detection unit 401 acquires the frequency characteristics of the input/output gain (amplitude ratio) and the phase shift of the servo control unit 100 from the frequency characteristic measurement unit 300. In Step S12, the resonance detection unit 401 detects the resonance points in the frequency characteristics of the input/output gain (amplitude ratio) and the phase shift output from the frequency characteristic measurement unit 300.

In Step S13, the resonance evaluation unit 402 calculates the priority levels of the resonance points on the basis of the distance between the resonance points on the Nyquist locus and the point on the real axis on the complex plane and the magnitude of the resonance frequency. First, in a frequency zone where frequency is lower than a high frequency zone, the resonance evaluation unit 402 calculates the priority levels based on the distance between the resonance points on the Nyquist locus and the point on the real axis on the complex plane. The high frequency zone is a frequency zone where the phase shift is -180 degrees or more or a frequency zone where the gain characteristic is smaller than -6 dB, for example. The priority level of the resonance point on the Nyquist locus closer to the point on the real axis on the complex plane is increased. The point on the real axis on the complex plane is determined by taking the gain margin and the phase margin into consideration. Specifically, the center of a circle passing through the gain margin and the phase margin is defined as the point on the real axis on the complex plane and, for example, the center of the circle passing through the gain margin and the phase margin is defined as (-1, 0) or (k, 0) (where k is a value less than -1). The value k is determined by the user by taking the gain margin and the phase margin into consideration.

In Step S14, after calculating the priority levels in the frequency zone where frequency is lower than the high frequency zone, the resonance evaluation unit 402 calculates the priority levels based on the distance between the resonance points on the Nyquist locus and the point on the real axis on the complex plane in the high frequency zone and the zone with higher frequency. In Step S15, the control assistance unit 400 determines whether to continue the processing for calculating the priority level of the resonance point. When determined to continue, the processing is returned to Step S11. When determined not to continue, the operation of the control assistance unit is ended.

According to the embodiment described above, it is possible to calculate the priority levels of a plurality of resonance points. The resonance evaluation unit 402 can configure the filter 130 (filters 130-1 to 130-m) shown in FIG. 1 by allocating the filters one by one to a plurality of resonance points in order from the resonance point with the calculated highest priority level. For example, the resonance evaluation unit 402 can configure the filter 130 shown in FIG. 1 by allocating the filters one by one to a plurality of resonance points in order from the resonance point with the highest priority level that has been calculated. When the resonance evaluation unit 402 allocates the filters, by detecting the antiresonance points by the resonance detection unit 401, the resonance evaluation unit 402 can set the range of attenuation center frequency of the filters to be allocated between the frequencies of the antiresonance points, when setting the range. Further, an allocation unit for allocating the filters one by one to a plurality of resonance points in order from the resonance point with the calculated highest priority level may be provided separately from the resonance evaluation unit 402. Even if there is a limit in the number of filters and there are resonance points more than the number of the filters, the resonance evaluation unit 402 can apply the filters in order from the resonance point with the highest priority level. Therefore, the filters may not be applied to the resonance points with low priority levels in an ineffectual manner.

### Second Embodiment

In the first embodiment, when measuring the frequency characteristics of the input/output gain (amplitude ratio) and the phase shift of the servo control unit 100, the frequency characteristic measurement unit 300 calculates the frequency characteristic from the speed command that is a sinusoidal wave signal having varying frequencies and the speed feedback. In the present embodiment, the frequency generation unit 200 inputs a sinusoidal wave signal to the pre-stage of the current control unit 140 while changing the frequency. Then, when measuring the frequency characteristics of the input/output gain and the phase shift of the servo control unit 100, the frequency characteristic measurement unit 300 calculates the frequency characteristic from the sinusoidal wave signal input to the pre-stage of the current control unit 140 and the output of the velocity control unit 120.

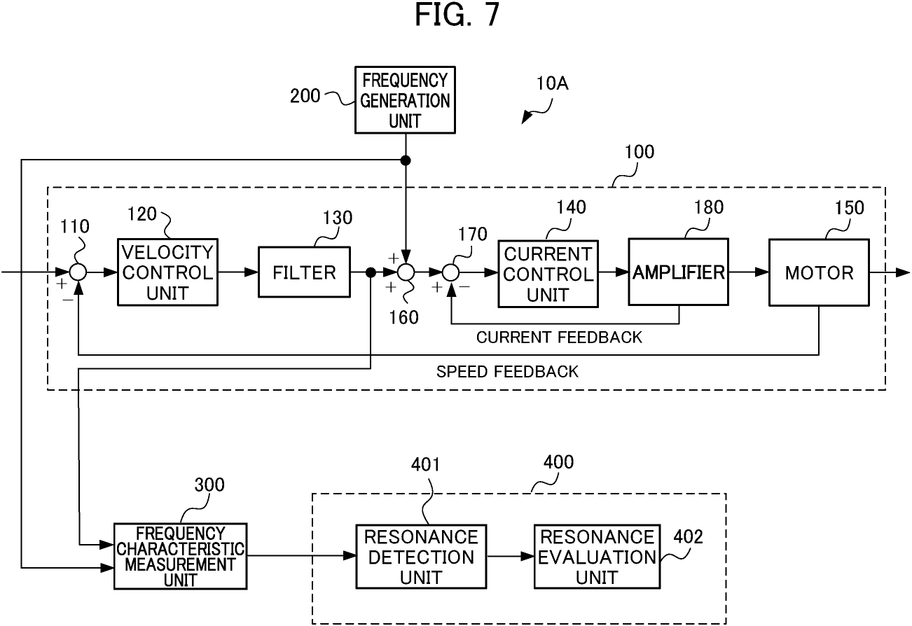

FIG. 7 is a block diagram showing a control system according to the second embodiment of the present disclosure. In FIG. 7, same reference numerals are applied to the same configuration members as those of the control system 10 shown in FIG. 1, and description thereof are omitted. As described in the first embodiment, the filter 130 is not provided when a priority levels of a plurality of resonance points are to be determined. As shown in FIG. 7, a control system 10A includes an adder 160 provided at a pre-stage of a subtractor 170, and a sinusoidal signal having varying frequencies output from the frequency generation unit 200 is input to the adder 160. The adder 160 is connected to the subtractor 170, and the current control unit 140 is connected to an amplifier 180. The amplifier 180 includes a current detector, and the current detected by the current detector is input to the subtractor 170. The subtractor 170, the current control unit 140, and the amplifier 180 configure a current feedback loop, and the current feedback loop is included in the speed feedback loop. The sinusoidal signal corresponds to a first signal having varying frequencies, and the output of the filter 130 corresponds to a second signal that is input to the current feedback loop in the speed feedback loop.

The inductance of the motor 150 is changed nonlinearly by the current flowing in the motor 150 due to an influence of magnetic saturation or the like. When the servo parameter before adjustment is changed to the servo parameter after adjustment, a torque command input to the current control unit 140 changes and, when the current gain of the current control unit 140 is constant, the current flowing in the motor 150 also changes. When the current flowing in the motor 150 changes and the inductance changes to a nonlinear form, the characteristic of the current feedback loop also changes to a nonlinear form.

In the present embodiment, the level of the input signal input to the subtractor 110 is set as zero, the frequency generation unit 200 inputs a sinusoidal signal to the pre-stage of the current control unit 140 while changing the frequency, and the frequency characteristic measurement unit 300 measures the frequency characteristics of the input/output gain and the phase shift of the servo control unit 100 from the sinusoidal signal and the output of the velocity control unit 120. In this manner, the input to the current feedback loop becomes constant. Therefore, it is possible to determine the priority levels of a plurality of resonance points by the control assistance unit 400 while keeping the linearity of the characteristic of the current feedback loop.

### Third Embodiment

In the first and second embodiments, the control assistance unit 400 determines the priority levels of a plurality of resonance points. In the present embodiment, described is a control system in which: a control assistance unit determines the priority levels of the resonance points; and a machine learning unit allocates filters one by one based on the priority levels, and determines optimal values of the coefficients of the allocated filters by machine learning to configure the filters 130-1 to 130-m. In the following description, a case of adding a machine learning unit to the control system 10 shown in FIG. 1 will be described. However, the machine learning unit may be added to the control system 10A shown in FIG. 7. In the following description, it is assumed that the machine learning unit allocates the filters one by one based on the priority levels of a plurality of resonance points, and determines optimal values of the coefficients of the allocated filters to configure the filters 130-1 to 130-m of the filter 130 of the servo control unit 100. However, as described in the first embodiment, the control assistance unit 400 may allocate the filters one by one in order from the resonance point with the calculated highest priority level, and determine optimal values of the coefficients of the filters allocated by the machine learning unit to configure the filters 130-1 to 130-m of the filter 130 of the servo control unit 100.

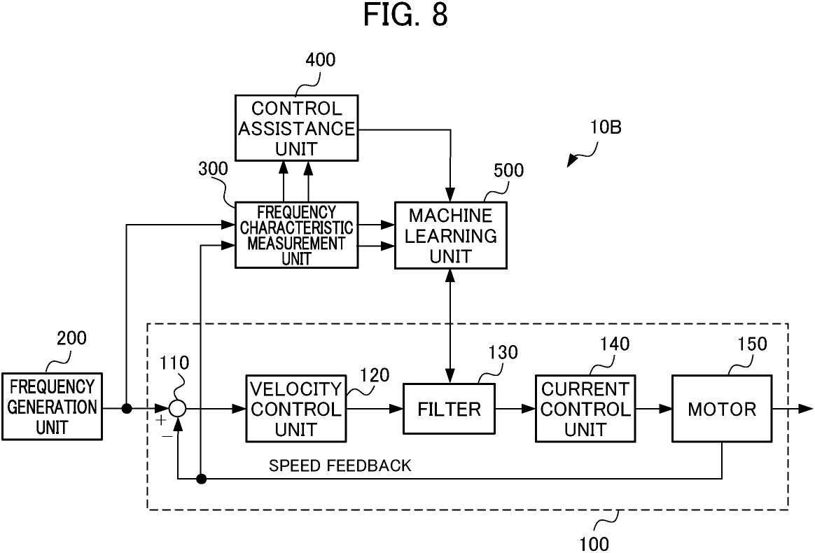

FIG. 8 is a block diagram showing a control system according to the third embodiment of the present disclosure. In FIG. 8, same reference numerals are applied to the same configuration members as shown in FIG. 1, and description thereof are omitted. As shown in FIG. 8, a control system 10B is in a configuration in which a machine learning unit 500 to be a machine learning device is added to the control system 10 shown in FIG. 1. The machine learning unit 500 acquires the priority levels of a plurality of resonance points and frequencies at each of the resonance points from the control assistance unit 400. The machine learning unit 500 acquires the frequency characteristics of the input/output gain and the phase shift of the servo control unit 100 output from the frequency characteristic measurement unit 300. Then, the machine learning unit 500 allocates the filters in order from the resonance point with the highest priority level output from the control assistance unit 400 so as to suppress a plurality of resonance points in the frequency characteristics of the input/output gain and the phase shift of the servo control unit 100, and performs machine learning (hereinafter, “machine learning” is referred to as “learning”) of the optimal values of each of the coefficients ω_{c}, τ, and δ of the transfer functions of the allocated filters. In the following description, it is assumed that the filter allocated first is the filter 130-1, and the filters 130-2 to 130-m are allocated thereafter in order. Then, the machine learning unit 500 sets each of the coefficients ω_{c}, τ, and δ of each of the transfer functions of the filters 130-1 to 130-m of the servo control unit 100 to the optimal values. While learning by the machine learning unit 500 is performed before shipment, re-learning may also be performed after shipment. Reinforcement learning may be used as the learning to be performed by the machine learning unit 500. However, the learning is not specifically limited to reinforcement learning, and supervised learning, for example, may be performed as well.

If the machine learning unit 500 is to allocate the filters in order from the highest frequency and learn the optimal values of each of the coefficients ω_{c}, τ, and δ of the filters when learning each of the coefficients ω_{c}, τ, and δ of each of the transfer functions of the filters 130-1 to 130-m, the filters may be applied in an ineffectual manner since each of the coefficients ω_{c}, τ, and δ of the filters is adjusted without knowing which resonance is most important. In the present embodiment, the machine learning unit 500 allocates the filters based on the priority levels of the resonance points acquired by the control assistance unit 400, and learns the optimal values of each of the coefficients ω_{c}, τ, and δ of the transfer functions of the allocated filters so as to suppress the resonance in order from the resonance point with the highest priority level. Therefore, it is possible to avoid learning the optimal values of each of the coefficients ω_{c}, τ, and δ of the transfer functions of the filters by applying the filters in an ineffectual manner.

Hereinafter, a supplemental description will be given regarding machine learning performed in the machine learning unit 500 to be the machine learning device.

### (Machine Learning Unit 500)

In the following description, a case where the machine learning unit 500 performs reinforcement learning will be described. The machine learning unit 500 performs Q-learning having, as a state S, the frequency characteristics of the input/output gain and the phase shift output from the frequency characteristic measurement unit 300, and having, as an action A, adjustment of the values of each of the coefficients ω_{c}, τ, and δ of the allocated filters of the filter 130 of the servo control unit 100 related to the state S. As known to those skilled in the art, an object of Q-learning is to select an action A having the highest value Q(S, A) as an optimal action among the actions A that can be taken in a certain state S.

Specifically, an agent (the machine learning device) selects various actions A under a certain state S, and selects a better action based on rewards given for the selected actions A to learn a correct value Q(S, A).

Further, since it is desired to maximize the total of rewards to be acquired in the future, it is aimed to finally achieve Q(S, A) = E[∑(γ^{t})rₜ]. Here, E[] indicates an expected value, t indicates time, γ is a parameter called a discount rate to be described later, rₜ is a reward at time t, and _{Σ} is the sum at time t. In this expression, the expected value is an expected value when the state is changed according to an optimal action. Such an updating expression for the value Q(S, A) can be represented by, for example, the following Mathematical expression 3 (shown as Expression 3 below).

$$Q \left({S}_{t + 1} , {A}_{t + 1}\right) ← Q \left({S}_{t} , {A}_{t}\right) + a \left({r}_{t + 1} + γ \text{} {m a x}_{A} Q \left({S}_{t + 1} , A\right) - Q \left({S}_{t} , {A}_{t}\right)\right) \qquad \text{[Expression 3]}$$

In the above Expression 3, Sₜ represents the state of the environment at the time t, and Aₜ represents an action at the time t. By the action Aₜ, the state changes to Sₜ₊₁. Note that rₜ₊₁ indicates a reward obtained by the change in the state. Moreover, a term with max is a multiplication of the value Q by γ when an action A having the highest value Q known at that moment is selected under the state Sₜ₊₁. Note here that γ is a parameter of 0<γ≤1 and is called a discount rate. Further, α is a learning coefficient and is defined to be in the range of 0<α≤1.

The above-mentioned Expression 3 shows a method of updating a value Q(Sₜ, Aₜ) of an action Aₜ in a state Sₜ based on a reward rₜ₊₁ returned as a result of a trial Aₜ.

The machine learning unit 500 observes state information S containing the frequency characteristics of the input/output gain and the phase shift for each frequency output from the frequency characteristic measurement unit 300, and determines the action A. The machine learning unit 500 receives a reward every time the action A is performed. The reward will be described later. In Q-learning, the machine learning unit 500, for example, searches for an optimal action A by trial and error such that the total of rewards in the future is maximized. This enables the machine learning unit 500 to select the optimal action A (that is, optimal servo parameter value) for the state S.

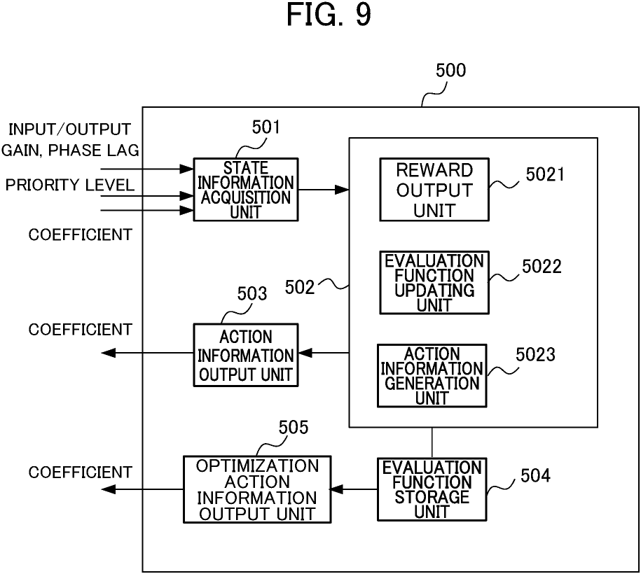

FIG. 9 is a block diagram showing the machine learning unit 500 according to an embodiment of the present invention. In order to perform the reinforcement learning described above, as shown in FIG. 9, the machine learning unit 500 includes a state information acquisition unit 501, a learning unit 502, an action information output unit 503, a value function storage unit 504, and an optimization action information output unit 505.

The state information acquisition unit 501 acquires the priority levels of a plurality of resonance points and the frequency at each of the resonance points from the control assistance unit 400, and outputs those to the learning unit 502. Further, the state information acquisition unit 501 allocates the filters in order from the resonance point with the highest priority level based on the priority levels of a plurality of resonance points, and outputs information specifying the allocated filters to the learning unit 502. As has already been described, the filter allocated first is defined as the filter 130-1, and the filters 130-2 o 130-m are allocated thereafter in order. Further, the state information acquisition unit 501 acquires, from the frequency characteristic measurement unit 300, the state S containing the input/output gain (amplitude ratio) and the phase shift acquired by driving the servo control unit 100 using the speed command (sinusoidal wave) based on each of the coefficients ω_{c}, τ, and δ of the transfer function of the filter 130-1, and outputs it to the learning unit 502. The state information S corresponds to an environmental state S in Q-learning.

Note that each of the coefficients ω_{c}, τ, and δ of the transfer function of the filter 130-1 at the time point when the Q-learning is first started is generated by the user in advance. In the present embodiment, initial setting values of each of the coefficients ω_{c}, τ, and δ of the transfer function of the filter 130-1 created by the user are adjusted to be optimal by reinforcement learning. As for the coefficients ω_{c}, τ, and δ, when the machine tool is adjusted in advance by an operator, machine learning may be performed by using the adjusted values as initial values.

The learning unit 502 is a unit for learning a value Q(S, A) when selecting a certain action A under a certain environmental state S. The learning unit 502 includes a reward output unit 5021, a value function updating unit 5022, and an action information generation unit 5023.

The reward output unit 5021 is a unit for calculating a reward when an action A is selected under a certain state S. When each of the coefficients ω_{c}, τ, δ, of the initial values of the filter 130-1 is adjusted, the reward output unit 5021 compares an input/output gain gs for each frequency of the bandwidth centering the resonance point selected according to the priority level with an input/output gain gb for each frequency of a normative model set in advance. When the input/output gain gs is larger than the value gb of the input/output gain of the normative model, the reward output unit 5021 gives a negative reward. On the other hand, when the input/output gain gs is equal to or smaller than the value gb of the input/output gain of the normative model, upon change of the state S to a state S′, the reward output unit 5021 gives a positive reward when the phase shift decreases, gives a negative reward when the phase shift increases, and gives a zero reward when there is no change in the phase shift.

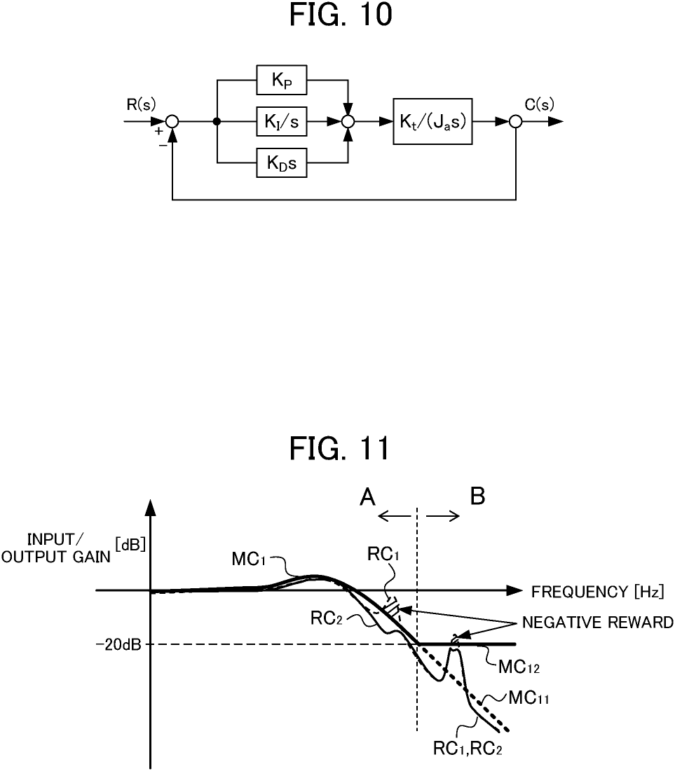

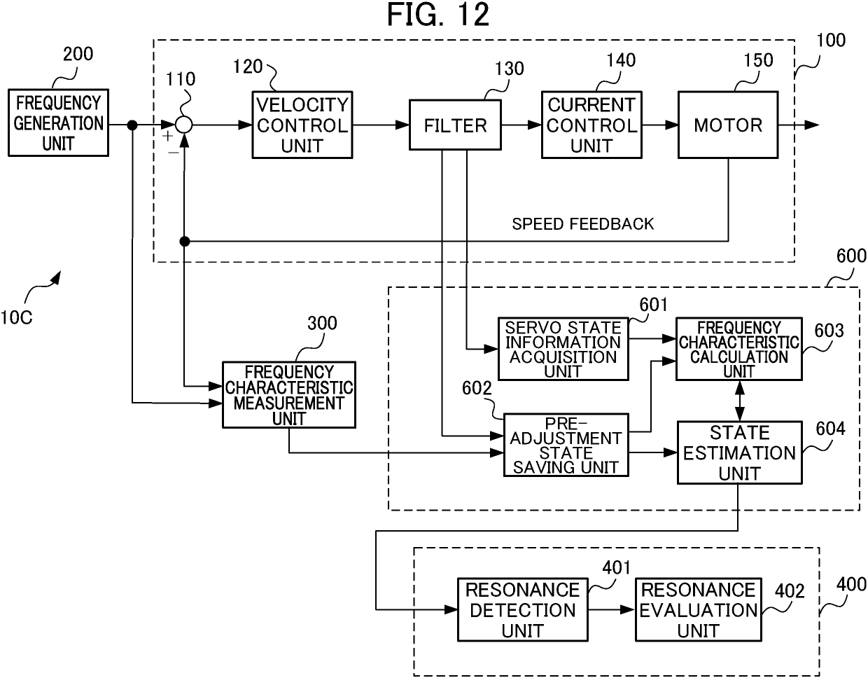

First, an operation of the reward output unit 5021 for giving a negative reward when the input/output gain gs is larger than the value gb of the input/output gain of the normative model will be described with reference to FIG. 10 and FIG. 11. The reward output unit 5021 saves the normative model of the input/output gain. The normative model is a model of a servo control unit with an ideal characteristic having no resonance. The normative model can be calculated from, for example, an inertia Jₐ, a torque constant Kₜ, a proportional gain Kₚ, an integral gain K_{I}, and a differential gain K_{D} of the model shown in FIG. 10. The inertia Jₐ is the sum of a motor inertia and a machine inertia.

FIG. 11 is a characteristic diagram showing the frequency characteristic of the input/output gain of the servo control unit of the normative model and the frequency characteristic of the input/output gain of the servo control unit 100 before and after learning. As shown in the characteristic diagram of FIG. 11, the normative model includes a zone A that is a frequency zone having an ideal input/output gain of a constant output/input gain or more, for example, -20 dB or more, and a zone B that is a frequency zone whose input/output gain is less than the constant input/output gain. In the zone A of FIG. 11, the ideal input/output gain of the normative model is represented by a curve MC₁ (bold line). In the zone B of FIG. 11, an ideal virtual input/output gain of the normative model is represented by a curve MC₁₁ (bold broken line), and the input/output gain of the normative model is represented by a straight line MC₁₂ (bold line) as a constant value. In the zones A and B of FIG. 11, the curves of the input/output gains of the servo control unit before and after learning are represented by curves RC₁ and RC₂, respectively.

In the zone A, the reward output unit 5021 gives a first negative reward when the curve RC₁ of the input/output gain before learning exceeds the curve MC₁ of the ideal input/output gain of the normative model in the bandwidth centered at the resonance point selected according to the priority level. In the zone B exceeding a frequency at which the input/output gain becomes sufficiently small, even when the curve RC₁ of the input/output gain before learning exceeds the curve MC₁₁ of the ideal virtual input/output gain of the normative model, the influence on stability is small. Therefore, in the zone B, as described above, not the curve MC₁₁ of the ideal gain characteristic, but the straight line MC₁₂ of the input/output gain of a constant value (for example, -20 dB) is used as the input/output gain of the normative model. However, when the curve RC₁ of the input/output gain before learning exceeds the straight line MC₁₂ of the input/output gain of a constant value in the bandwidth centered at the resonance point selected according to the priority level, it may cause instability, so that a first negative value is given as a reward.

Next, description will be given on an operation of the reward output unit 5021 for determining a reward based on the phase shift, which is performed when the input/output gain gs is equal to or less than the value gb of the input/output gain of the normative model. In the following description, a phase shift that is a state variable number related to the state information S is represented by D(S), and a phase shift that is a state variable number related to the state S′ changed from the state S due to action information A (adjustment of the servo parameter values) is represented by D(S′). Since the phase shift is not acquired at the time point when the Q-learning is first started, the following rewards are determined by using, as the phase shift D(S), the phase shift of the servo control unit 100 acquired by operating the servo control unit 100 by the servo parameters of the initial values acquired from the frequency characteristic measurement unit 300.

As a method for determining a reward based on the phase shift by the reward output unit 5021, there are following methods, for example. The reward output unit 5021 can determine the reward depending on whether the frequency at which the phase shift equals to 180 degrees increases, decreases, or does not change, when the state S is changed to the state S′. While the case where the phase shift is 180 degrees is discussed herein, the phase shift is not specifically limited to 180 degrees but may take other values. For example, assuming that the phase shift is indicated in the phase plot shown in FIG. 8, when the curve changes such that the frequency at which the phase shift equals to 180 degrees decreases (in X₂ direction of FIG. 3) upon change of the state S to the state S′, the phase shift increases. On the other hand, when the curve changes such that the frequency at which the phase shift equals to 180 degrees increases (in X₁ direction of FIG. 3) upon change of the state S to the state S′, the phase shift decreases.

Therefore, it is defined as the phase shift D(S) < the phase shift D(S′) when the frequency at which the phase shift equals to 180 degrees decreases upon change of the state S to the state S′, and the reward output unit 5021 determines the value of the reward as a second negative value. Note that the absolute value of the second negative value is set to be smaller than the first negative value. On the other hand, it is defined as the phase shift D(S) > the phase shift D(S′) when the frequency at which the phase shift equals to 180 degrees increases upon change of the state S to the state S′, and the reward output unit 5021 determines the value of the reward as a positive value. Moreover, it is defined as the phase shift D(S) = the phase shift D(S′) when the frequency at which the phase shift equals to 180 degrees does not change upon change of the state S to the state S′, and the reward output unit 5021 determines the value of the reward as zero value.

The method for determining the reward based on the phase shift is not limited to the above method. It is also possible to use a method that, upon change of the state S to the state S′, a reward of the second negative value may be given when the phase margin decreases, a reward of the positive value may be given when the phase margin increases, and a zero reward may be given when there is no change.

The reward output unit 5021 is described above.

The value function updating unit 5022 performs Q-learning based on the state S, the action A, the state S′ where the action A is applied to the state S and the reward acquired in the manner described above to update a value function Q stored in the value function storage unit 504. The value function Q may be updated by online learning, batch learning, or mini-batch learning. Online learning is a learning method for updating the value function Q immediately whenever the current state S transits to the new state S′ by applying a certain action A to the current state S. Further, batch learning is a learning method for repeating transition of the state S to the new state S′ by applying a certain action A to the current state S to collect data for learning, and updating the value function Q by using all the collected learning data. Further, mini-batch learning is a learning method that is intermediate between online learning and batch learning and involves updating the value function Q whenever a certain amount of learning data is collected.

The action information generation unit 5023 selects the action A in the process of Q-learning for the current state S. In the process of Q-learning, the action information generation unit 5023 creates action information A and outputs the created action information A to the action information output unit 503 in order to perform an operation of adjusting each of the coefficients ω_{c} and τ of the transfer function of the allocated filter 130-1 (corresponding to the action A in Q-learning). More specifically, the action information generation unit 5023, for example, may incrementally add or subtract the respective coefficients ω_{c}, τ, and δ of the transfer function of the filter 130-1 contained in the action A to or from the adjusted filter 130-1 contained in the state S.

The action information generation unit 5023 may modify all of the respective coefficients ω_{c}, τ, δ of the filter 130-1, or may modify some of the coefficients. When the action information generation unit 5023 adjusts each of the coefficients ω_{c}, τ, δ of the filter 130-1, for example, the center frequency fc at which resonance occurs is easily found, and the center frequency fc is easily specified. Therefore, in order to perform an operation of temporarily fixing the center frequency fc and modifying the bandwidth fw and the attenuation coefficient δ, that is, fixing the coefficient ω_{c} (= 2πfc) and modifying the coefficient τ(= fw/fc) and the attenuation coefficient δ, the action information generation unit 5023 may generate the action information A and output the generated action information A to the action information output unit 503.

Further, the action information generation unit 5023 may adopt a measure for selecting an action A′ by a known method such as a greedy method that selects an action A′ having the highest value Q(S, A) among the values of currently estimated actions A or an ε greedy method that randomly selects an action A′ with a small probability ε and selects an action A′ having the highest value Q(S, A) in the other cases.

The action information output unit 503 is a unit for transmitting the action information A output from the learning unit 502 to the servo control unit 100. As described above, by adjusting the current state S, that is, the currently set respective coefficients ω_{c}, τ, and δ of the filter 130-1 based on the action information, the current state S transits to the next state S′ (that is, the adjusted respective coefficients ω_{c}, τ, and δ of the filter 130-1).

The value function storage unit 504 is a storage device for storing the value function Q. The value function Q may be stored as a table (hereinafter, referred to as an action value table) for each state S and each action A, for example. The value function Q stored in the value function storage unit 504 is updated by the value function updating unit 5022. Further, the value function Q stored in the value function storage unit 504 may be shared with another machine learning unit 500. By sharing the value function Q by a plurality of machine learning units 500, each of the machine learning units 500 can perform reinforcement learning in a distributive manner, so that the efficiency of reinforcement learning can be improved.

The optimization action information output unit 505 generates the action information A (hereinafter referred to as “optimization action information”) for causing the filter 130-1 allocated according to the priority levels of the resonance points to perform an operation maximizing the value Q(S, A) based on the value function Q updated by performing the Q-learning by the value function updating unit 5022. More specifically, the optimization action information output unit 505 acquires the value function Q stored in the value function storage unit 504. This value function Q is updated by performing Q-learning by the value function updating unit 5022 as described above. Then, the optimization action information output unit 505 generates action information based on the value function Q, and outputs the generated action information to the filter 130-1 of the servo control unit 100. This optimization action information contains information for modifying each of the coefficients ω_{c}, τ, and δ of the transfer function of the filter 130-1 of the filter 130 of the servo control unit 100.

In the filter 130-1 of the filter 130, each of the coefficients ω_{c}, τ, and δ of the transfer function is modified based on the action information. The machine learning unit 500 can be operated to further perform optimization of the respective coefficients ω_{c}, τ, and δ of the respective transfer functions of the filters 130-2 to 130-m sequentially to suppress the resonance by the filters 130-1 to 130-m. The use of the machine learning unit 500 makes it possible to simplify adjustment of each of the coefficients ω_{c}, τ, and δ of the respective transfer functions of the filters 130-1 to 130-m.

As described above, the machine learning unit 500 allocates the filters based on the priority levels of a plurality of resonance points, and learns the optimal values of each of the coefficients ω_{c}, τ, and δ of the transfer functions of the allocated filters so as to suppress the resonance in order from the resonance point with the highest priority level. However, even when the machine learning unit 500 learns the optimal values of each of the coefficients ω_{c}, τ, and δ of the transfer functions of the allocated filters so as to suppress the resonance in order from the resonance point with the highest priority level, an evaluation function of the cutoff frequency or the like may not be improved.

Therefore, even for the resonance point with the high priority level, the machine learning unit 500 may not apply the filter when the evaluation function is not to be improved. When the evaluation function is the cutoff frequency, the filter is not applied when the cutoff frequency does not increase. The cutoff frequency is, for example, a frequency at which the gain characteristic of the bode diagram is equal to -3 dB, or a frequency at which the phase characteristic is equal to -180 degrees. As the cutoff frequency increases, the feedback gain increases and the response speed increases. Whether the cutoff frequency is improved is determined by the reward output unit 5021 or the action information generation unit 5023 of the machine learning unit 500 by using the bode diagram acquired by measuring the frequency characteristic calculated from the input/output gain of the servo control device.

As the evaluation function, there may be |1-(gain characteristic of closed loop)|², |1-(closed-loop transfer function) |², or the like, other than the cutoff frequency. The closed-loop transfer function can be calculated using G(jω) = A(ω)e-^{jθ(ω)} from the gain A(ω) and the phase shift θ(ω) of the bode diagram. By not applying the filters even for the resonance point with the high priority level when the evaluation function is not to be improved, the system can be stably operated in a highly responsible manner without allocating ineffectual filter.

### Modification Example

In the control systems according to the first to third embodiments, when adjusting the coefficients of the allocated filters of the servo control unit 100, the servo control unit is operated every time the coefficients of the filter are adjusted to measure the frequency characteristics of the input/output gain and the phase shift.

Hereinafter, as a Modification Example, described is a control system capable of shortening the time for measuring the frequency characteristics of the input/output gain and the phase shift. The Modification Example described below is an example in which a frequency characteristic estimation unit for acquiring an estimation value of the frequency characteristics of the input/output gain (amplitude ratio) and the phase shift is inserted to the control system of the first embodiment shown in FIG. 1.

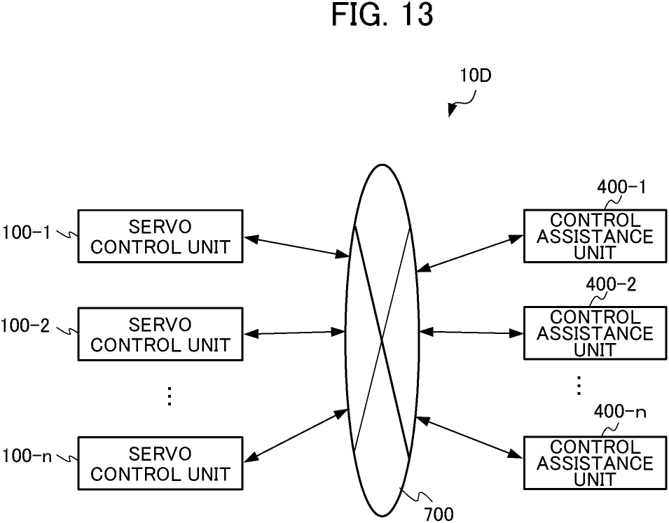

FIG. 12 is a block diagram showing the Modification Example of the control system shown in FIG. 1. In a control system 10C of the present Modification Example, a frequency characteristic estimation unit 600 for acquiring an estimation value of the frequency characteristics of the input/output gain and the phase shift is provided at a post-stage of the frequency characteristic measurement unit 300. The frequency characteristic estimation unit 600 acquires the estimation values of the frequency characteristics of the input/output gain (amplitude ratio) and the phase shift after adjustment, by using the frequency characteristics of the input/output gain (amplitude ratio) and the phase shift output from the frequency characteristic measurement unit 300 by an operation of the servo control unit 100 with the coefficients of the filter before adjustment (hereinafter, description will be given assuming that the allocated filter is the filter 130-1). The control system 10C uses the frequency characteristic estimation unit 600 to operate the servo control unit every time the coefficients of the filter 130-1 are adjusted, so that it is not necessary to measure the frequency characteristics of the input/output gain and the phase shift. As a result, the time for measuring the frequency characteristics of the input/output gain and the phase shift can be shortened.

The frequency characteristic estimation unit 600 saves a frequency characteristic P of the input gain (amplitude ratio) and the phase shift of the servo control unit 100 output from the frequency characteristic measurement unit 300 by an operation of the servo control unit 100 with the filter 130 having the coefficients before adjustment. The frequency characteristic estimation unit 600 uses each of the coefficients ω_{c}, τ, and δ of the transfer function of the filter 130-1 before adjustment (to be second information) to calculate a frequency characteristic C₂ of the input/output gain and the phase shift of the filter 130-1.

Further, the frequency characteristic estimation unit 600 uses each of the coefficients ω_{c}, τ, and δ of the transfer function of the filter 130-1 before adjustment (to be first information) to calculate a frequency characteristic C₁ of the input/output gain and the phase shift of the filter 130-1.

Then, the frequency characteristic estimation unit 600 acquires an estimation value E of the frequency characteristics of the input/output gain and the phase shift of the servo control unit 100 based on the frequency characteristic C₁, the frequency characteristic C₂, and the frequency characteristic P. Specifically, the estimation value E of the frequency characteristics of the input/output gain and the phase shift of the servo control unit 100 is acquired using the following Mathematical expression 4 (hereinafter, shown as Expression 4).

$${\text{E = C}}_{1} - {\text{C}}_{2} + \text{P} \qquad \text{[Expression 4]}$$

While the estimation value E of the frequency characteristics of the input/output gain and the phase shift of the servo control unit 100 can be acquired using Mathematical expression 4 described above, that is, E = C₁-C2+P, any of expressions E = (C₁-C₂)+P, E = (P-C₂)+C₁, or E = (P+C₁)-C₂ may be used for the calculation performed by the frequency characteristic estimation unit 600 for acquiring the estimation value E.

Hereinafter, details of the configuration and operation of the frequency characteristic estimation unit 600 will be further described.

### (Frequency Characteristic Estimation Unit 600)

As shown in FIG. 12, the frequency characteristic estimation unit 600 includes a servo state information acquisition unit 601, an pre-adjustment state saving unit 602, a frequency characteristic calculation unit 603, and a state estimation unit 604.

The servo state information acquisition unit 601 acquires each of the coefficients ω_{c}, τ, and δ of the transfer function of the filter 130-1 after adjustment (hereinafter, referred to as first information), and outputs it to the frequency characteristic calculation unit 603.

Note that each of the coefficients ω_{c}, τ, and δ of the transfer function of the filter 130-1 before adjustment is generated in advance by the user.

As described above, the pre-adjustment state saving unit 602 saves the frequency characteristic P of the input/output gain and the phase shift of the servo control unit 100 output from the frequency characteristic measurement unit 300. Further, the pre-adjustment state saving unit 602 saves each of the coefficients ω_{c}, τ, and δ of the transfer function of the filter 130-1 before adjustment (hereinafter, referred to as second information) which is output from the filter 130.

The frequency characteristic calculation unit 603 acquires the first information from the servo state information acquisition unit 601, and reads out the second information from the pre-adjustment state saving unit 602. Then, the frequency characteristic calculation unit 603 uses the transfer function G_{F}(jω) of the filter 130-1 contained in the first information to calculate the frequency characteristic C₁ of the input/output gain and the phase shift of the filter 130-1. Further, the frequency characteristic calculation unit 603 uses the transfer function G_{F}(jω) of the filter 130-1 contained in the second information to calculate the frequency characteristic C₂ of the input/output gain and the phase shift of the filter 130-1.

Then, the frequency characteristic calculation unit 603 outputs the calculated frequency characteristic C₁ and frequency characteristic C₂ to the state estimation unit 604.

The state estimation unit 604 uses the Mathematical expression 4 (E = (C₁-C₂)+P) to acquire the estimation value E of the frequency characteristics of the input/output gain and the phase shift of the servo control unit 100 based on the frequency characteristic C₁, the frequency characteristic C₂, and the frequency characteristic P. The acquired estimation value E is input to the control assistance unit 400, and the control assistance unit 400 can use the estimation value E to acquire the priority level of the resonance point when each of the coefficients of the allocated filter is adjusted. While the case of the filter 130-1 has been described above, it is also the same for the filters 130-2 to 130-m.

In the present Modification Example, the estimation values of the frequency characteristics of the input/output gain and the phase shift of the servo control unit with each of the coefficients of the allocated filter after adjustment can be calculated by the frequency characteristic estimation unit 600. Therefore, it is possible to acquire the estimation values in shorter time compared to the case where the servo control unit 100 is operated with each of the coefficients of the allocated filter after adjustment to actually detect the speed command and the detection speed, and the frequency characteristic measurement unit 300 measures the frequency characteristics of the input/output gain and the phase shift.

While the Modification Example described above is an example in which the frequency characteristic estimation unit for acquiring estimation values of the frequency characteristics of the input/output gain (amplitude ratio) and the phase shift is inserted to the control system of the first embodiment shown in FIG. 1, the frequency characteristic estimation unit may be inserted to the control system of the second embodiment shown in FIG. 7 or the control system of the third embodiment shown in FIG. 8.

In a case where the frequency characteristic estimation unit 600 is inserted to the control system of the third embodiment shown in FIG. 8, the machine learning unit 500, when each of the coefficients of the allocated filter is adjusted, performs learning using the estimated values of the frequency characteristics of the input/output gain and the phase shift of the servo control unit 100 acquired by the frequency characteristic estimation unit 600. In the third embodiment, it is described that the machine learning unit 500 does not apply the filter even to the resonance point with the high priority level when the cutoff frequency to be the evaluation function is not to be improved. Whether the cutoff frequency is improved may also be determined by inserting the frequency characteristic estimation unit 600 to the control system 10B, and using the bode diagram that is created by using the estimation values of the frequency characteristics of the input/output gain and the phase shift of the servo control unit 100 acquired by the frequency characteristic estimation unit 600.

### Another Modification Example

As for a Modification Example of the control system, there is the following configuration other than the configuration of FIG. 12.

### (Modification Example in Which the Control Assistance Unit Is Connected to the Servo Control Unit Via a Network)

FIG. 13 is a block diagram showing another Modification Example of the control system. A control system 10D shown in FIG. 13 can be applied to the control systems 10 and 10A of the first and second embodiments shown in FIG. 1 an FIG. 7. The difference of the control system 10D from the control system 10 and the control system 10A resides in that n (n represents a natural number of 2 or more) servo control units 100-1 to 100-n are connected to n control assistance units 400-1 to 400-n via a network 700, and each of the servo control units includes a frequency generation unit 200 and a frequency characteristic measurement unit 300. The control assistance units 400-1 to 400-n have the same configuration as the control assistance unit 400 shown in FIG. 1. Each of the servo control units 100-1 to 100-n corresponds to the servo control device, and each of the control assistance units 400-1 to 400-n corresponds to the control assistance device. It is needless to say that one or both of the frequency generation unit 200 and the frequency characteristic measurement unit 300 may be provided outside the servo control units 100-1 to 100-n.

The configuration shown in FIG. 13 may be applied to the control system 10B of FIG. 8. In that case, each of the servo control units 100-1 to 100-n includes a machine learning unit 500. It is also needless to say that the machine learning unit 500 may be provided outside the servo control units 100-1 to 100-n. Further, the configuration shown in FIG. 13 may be applied to the control system 10C of FIG. 12. In that case, each of the servo control units 100-1 to 100-n includes the frequency characteristic estimation unit 600. It is also needless to say that the frequency characteristic estimation unit 600 may be provided outside the servo control units 100-1 to 100-n.

Note here that the servo control unit 100-1 and the control assistance unit 400-1 are made into a one-to-one pair, and are connected to each other to be able to communicate with each other. As for the servo control units 100-2 to 100-n and the control assistance units 400-2 to 400-n, they are also connected in the same manner as the servo control unit 100-1 and the control assistance unit 400-1. In FIG. 13, the n pairs of the servo control units 100-1 to 100-n and the control assistance units 400-1 to 400-n are connected via the network 700. The servo control unit and the control assistance unit in each of the n pairs of the servo control units 100-1 to 100-n and the control assistance units 400-1 to 400-n may also be directly connected to each other via a connection interface. As for the n pairs of the servo control units 100-1 to 100-n and the control assistance units 400-1 to 400-n, for example, several of the pairs may be installed in the same factory, or the n pairs may be installed in different factories, respectively.

The network 700 is, for example, a LAN (Local Area Network) constructed in a factory, the Internet, a public telephone network, or a combination thereof. There is no limit specifically set for the network 700 in regards to a specific communication style, whether it is of a wired connection or a wireless connection, and the like.

### (Degree of Freedom of System Configuration)

In the embodiments described above, the servo control units 100-1 to 100-n and the control assistance units 400-1 to 400-n are made into one-to-one pairs so as to be able to communicate with each other. A single control assistance unit, for example, may also be connected to a plurality of servo control units via the network 700 so as to be able to communicate with each other to perform control assistance for each of the servo control units. At that time, each of the functions of a single control assistance unit may be appropriately distributed to a plurality of servers as a distributed processing system. Further, each of the functions of a single control assistance unit may be implemented by using a virtual server function or the like on the cloud.

Further, when there are n control assistance units 400-1 to 400-n corresponding to the servo control units 100-1 to 100-n of the same model name, the same specifications, or the same series, the estimation results in the each of the control assistance units 400-1 to 400-n may be shared. By doing so, it becomes possible to construct a more optimal model.

The first, second, and third embodiments as well as the two Modification Examples are described above. Each component included in the control systems of each of the embodiments and each of the Modification Examples can be implemented by hardware, software, or a combination thereof. Further, the servo control method to be performed by the cooperation of the respective components included in the above control systems can also be implemented by hardware, software, or a combination thereof. Here, being implemented by software means being implemented when a computer reads and executes a program.

The program can be stored and supplied to a computer by using various types of non-transitory computer-readable media. The non-transitory computer-readable media include various types of tangible storage media. Examples of the non-transitory computer-readable media may be a magnetic recording medium (for example, hard disk drive), a magnetooptical recording medium (for example, magnetooptical disc), CD-ROM (Read Only Memory), CD-R, CD-R/W, and a semiconductor memory (for example, a mask ROM, a PROM (Programmable ROM), an EPROM (Erasable PROM), a flash ROM, and a RAM (random access memory)).

Each of the above-described embodiments is a preferred embodiment of the present invention. However, the scope of the present invention is not limited to the above-described embodiments, and the present invention can be embodied in various modifications without departing from the spirit of the present invention.

The control assistance device, the control system, and the control assistance method according to the present disclosure can take various embodiments having the following configurations, including the above-described embodiments. (1) A control assistance device (for example, the control assistance unit 400) that performs assistance for adjusting a coefficient for a plurality of filters (for example, the filters 130-1 to 130-m) provided to a servo control device (for example, the servo control unit 100) that controls a motor (for example, the motor 150), the control assistance device including: a resonance detection unit (for example, the resonance detection unit 401) that detects a plurality of resonance points in frequency characteristics of an input/output gain and an input/output phase shift, of the servo control device, measured based on an input signal and an output signal having varying frequencies; and a resonance evaluation unit (for example, the resonance evaluation unit 402) that calculates priority levels of the plurality of resonance points, wherein the resonance evaluation unit calculates the priority levels on the basis of a distance between a point (-1, 0) or a point (k, 0) (where k is a value less than -1) on a real axis on a complex plane, and a resonance point on a Nyquist locus calculated from the frequency characteristics of the input/output gain and the input/output phase shift.

With the control assistance device, it is possible to determine the priority levels of the resonance points. As a result, it is possible to allocate the filters in order from the resonance point with the highest priority level.

(2) The control assistance device described in the foregoing (1), wherein the resonance evaluation unit calculates the priority levels on the basis of the distance and a magnitude of a resonance frequency.

(3) The control assistance device described in the foregoing (1) or (2), wherein the resonance evaluation unit allocates the filters one by one from the resonance point with a highest priority level.

(4) A control system (for example, the control system 10, 10A, 10B, 10C, or 10D) including: a servo control device (for example, the servo control unit 100) that controls a motor; and the control assistance device (for example, the control assistance unit 400) described in any one of the foregoing (1) to (3), the control assistance device including: detecting the plurality of resonance points in the frequency characteristics of the input/output gain and the input/output phase shift of the servo control device; and calculating the priority levels of the plurality of resonance points.

With the control system, it is possible to determine the priority levels of the resonance points. As a result, it is possible to allocate the filters in order from the resonance point with the highest priority level.

(5) The control system described in the foregoing (4), including a machine learning device (for example, the machine learning unit 500) that optimizes the coefficient of the filters allocated in order from the resonance point with a highest priority level based on the priority levels of the plurality of resonance points. With the control system, adjustment of the coefficient of the filters can be simplified and performed in short time.

(6) The control system described in the foregoing (5), wherein even for the resonance point with the highest priority level, the machine learning device does not apply the filter when an evaluation function is not to be improved. With the control system, it is possible to avoid learning the optimal value of the coefficient of the filters by applying the filters in an ineffectual manner.

(7) The control system described in any one of the foregoing (4) to (6), including: a frequency generation device (for example, the frequency generation unit 200) that generates a signal having varying frequencies, and inputs the signal to the servo control device; and a frequency characteristic measurement device (for example, the frequency characteristic measurement unit 300) that measures the frequency characteristics of the input/output gain and the input/output phase shift of the servo control device based on the signal and an output signal of the servo control device.

(8) The control system described in any one of the foregoing (4) to (6), wherein the servo control device includes a current feedback loop that controls a current flowing in the motor, and a feedback loop including the current feedback loop and the filters, the control system including: a frequency generation device (for example, the frequency generation unit 200) that generates a first signal having varying frequencies, and inputs the first signal to the current feedback loop; and a frequency characteristic measurement unit (for example, the frequency characteristic measurement unit 300) that measures the frequency characteristics of the input/output gain and the input/output phase shift of the servo control device, based on the first signal and a second signal input to the current feedback loop in the feedback loop.

(9) A control assistance method (for example, the control assistance unit 400) for a control assistance device that performs assistance for adjusting a coefficient for a plurality of filters provided to a servo control device (for example, the servo control unit 100) that controls a motor (for example, the motor 150), the control assistance method including: detecting a plurality of resonance points in frequency characteristics of an input/output gain and an input/output phase shift, of the servo control device, measured based on an input signal and an output signal having varying frequencies; and calculating priority levels of the plurality of resonance points on the basis of a distance between a point (-1, 0) or a point (k, 0) (where k is a value less than -1) on a real axis on a complex plane, and a resonance point on a Nyquist locus calculated from the frequency characteristics of the input/output gain and the input/output phase shift.

With the control assistance method, it is possible to determine the priority levels of the resonance points. As a result, it is possible to allocate the filters in order from the resonance point with the highest priority level.

EXPLANATION OF REFERENCE NUMERALS
10, 10A, 10B, 10C, 10D Control system
100, 100-1 to 100-n Servo control unit
110 Subtractor
120 Velocity control unit
130, 130-1 to 130-m Filter
140 Current control unit
150 Motor
200 Frequency generation unit
300 Frequency characteristic measurement unit
400, 400-1 to 400-n Control assistance unit
401 Resonance detection unit
402 Resonance evaluation unit
500 Machine learning unit
501 State information acquisition unit
502 Learning unit
503 Action information output unit
504 Value function storage unit
505 Optimization action information output unit
600 Frequency characteristic estimation unit
700 Network

1. A control assistance device that performs assistance for adjusting a coefficient for a plurality of filters provided to a servo control device that controls a motor, the control assistance device comprising:
a resonance detection unit that detects a plurality of resonance points in frequency characteristics of an input/output gain and an input/output phase shift, of the servo control device, measured based on an input signal and an output signal having varying frequencies; and
a resonance evaluation unit that calculates priority levels of the plurality of resonance points,
wherein the resonance evaluation unit calculates the priority levels on the basis of a distance between a point (-1, 0) or a point (k, 0) (where k is a value less than -1) on a real axis on a complex plane, and a resonance point on a Nyquist locus calculated from the frequency characteristics of the input/output gain and the input/output phase shift.

2. The control assistance device according to claim 1,
wherein the resonance evaluation unit calculates the priority levels on the basis of the distance and a magnitude of a resonance frequency.

3. The control assistance device according to claim 1,
wherein the resonance evaluation unit allocates the filters one by one from the resonance point with a highest priority level.

4. A control system comprising:
a servo control device that controls a motor; and
the control assistance device according to claim 1,
the control assistance device comprising:
detecting the plurality of resonance points in the frequency characteristics of the input/output gain and the input/output phase shift of the servo control device; and
calculating the priority levels of the plurality of resonance points.

5. The control system according to claim 4, comprising a machine learning device that optimizes the coefficient of the filters allocated in order from the resonance point with a highest priority level based on the priority levels of the plurality of resonance points.

6. The control system according to claim 5, wherein, even for the resonance point with the highest priority level, the machine learning device does not apply the filter when an evaluation function is not to be improved.

7. The control system according to claim 4, comprising:
a frequency generation device that generates a signal having varying frequencies, and inputs the signal to the servo control device; and
a frequency characteristic measurement device that measures the frequency characteristics of the input/output gain and the input/output phase shift of the servo control device based on the signal and an output signal of the servo control device.

8. The control system according to claim 4, wherein the servo control device comprises a current feedback loop that controls a current flowing in the motor, and a feedback loop including the current feedback loop and the filters,
the control system comprising:
a frequency generation device that generates a first signal having varying frequencies, and inputs the first signal to the current feedback loop; and
a frequency characteristic measurement unit that measures the frequency characteristics of the input/output gain and the input/output phase shift of the servo control device, based on the first signal and a second signal input to the current feedback loop in the feedback loop.

9. A control assistance method for a control assistance device that performs assistance for adjusting a coefficient for a plurality of filters provided to a servo control device that controls a motor, the control assistance method comprising:
detecting a plurality of resonance points in frequency characteristics of an input/output gain and an input/output phase shift, of the servo control device, measured based on an input signal and an output signal having varying frequencies; and
calculating priority levels of the plurality of resonance points on the basis of a distance between a point (-1, 0) or a point (k, 0) (where k is a value less than -1) on a real axis on a complex plane, and a resonance point on a Nyquist locus calculated from the frequency characteristics of the input/output gain and the input/output phase shift.
